(19) United States
(12) Patent Application Publication
(10) Pub. No.: US 2017/0258668 A1
(43) Pub. Date: Sep. 14, 2017

(54) MASSAGING APPARATUS AND CHAIR MASSAGER EQUIPPED WITH THE MASSAGING APPARATUS

(71) Applicant: DAITO ELECTRIC MACHINE INDUSTRY COMPANY LIMITED, Higashi-Osaka-shi, Osaka (JP)

(72) Inventors: Yasushi SONE, Higashi-Osaka-shi (JP); Fumitaka ISHIGURO, Higashi-Osaka-shi (JP); Shinsaku SHIMIZU, Higashi-Osaka-shi (JP)

(73) Assignee: DAITO ELECTRIC MACHINE INDUSTRY COMPANY LIMITED, Higashi-Osaka-shi, Osaka (JP)

(21) Appl. No.: 15/123,608

(22) PCT Filed: Apr. 5, 2016
(86) PCT No.: PCT/JP2016/061094

§ 371 Date: Sep. 2, 2016

(30) Foreign Application Priority Data
Nov. 17, 2015 (JP) 2015-224859

(51) Int. Cl. A61H 7/00; A61H 15/00; A61H 1/00

(52) U.S. Cl. CPC A61H 7/007; A61H 1/008; A61H 15/0078; A61H 2007/009; A61H 2201/1671; A61H 2201/1623; A61H 2203/0425

(57) ABSTRACT

There are provided a massaging apparatus capable of providing comfortable kneading and massaging effects and reducing damage to a cover covering massaging elements, and a chair massager having the massaging apparatus.

The massaging apparatus comprises horizontally arranged paired massaging members (10,11) having massaging elements (91 to 94) and a massaging mechanism (12) for producing kneading action by operating at least one of the massaging members (10,11) so that the massaging elements (91 to 94) have horizontal approaching-separating movement. The massaging member (10,11) includes an arm member (15,16) extending in a direction substantially perpendicular to the direction of approaching-separating movement. The massaging element (91 to 94) is attached to the tip of the arm member (15,16) for rotation about the axis of an extension line (L) extending along the extending direction of the arm member (15,16) and about an axis pointing in a direction substantially perpendicular to the extension line (L).

### TECHNICAL FIELD

The present invention relates to a massaging apparatus and a chair massager equipped with the massaging apparatus.

### BACKGROUND ART

There is a heretofore known chair massager having a backrest in which is installed a massaging apparatus for operating a pair of right and left massaging members to perform massage.

The massaging member mounted in the massaging apparatus of this type comprises an arm member extending outwardly from within the backrest toward a user, and a massaging element (kneading ball) disposed at the tip of the arm member. The massaging apparatus is designed to perform kneading massage on user's back by operating the massaging elements disposed at the tips of, respectively, the massaging members to move close to and away from each other in a horizontal direction (refer to Patent Literature 1, for example).

Moreover, in the massaging apparatus disclosed in Patent Literature 1, the massaging member is moved in a vertical direction by a vertical movement mechanism (up-and-down movement mechanism) housed inside the backrest. That is, the level of the massaging element can be varied during kneading massage, thus performing kneading massage over a wide range of user's back in the vertical direction.

### PRIOR ART REFERENCE

### Citation List

Patent Literature 1: Japanese Unexamined Patent Publication JP-A 2015-24088

### SUMMARY OF INVENTION

### Technical Problem

In the massaging apparatus disclosed in Patent Literature 1, the massaging element of the massaging apparatus has a substantially spherical shape, and is rotatable about an axis extending from the tip of the arm member. Accordingly, the massaging element is rotatable in the horizontal direction, and, when reciprocated in the horizontal direction during kneading massage, the massaging element moves so as to roll over a to-be-massaged area of user's body, thus enabling the user to feel adequate kneading effects. Moreover, since the massaging element moves so as to roll in the horizontal direction during kneading massage, it never occurs that the massaging element is rubbed against a cover lying between the massaging element and the user (a cover made of fabric or the like). This makes it possible to protect the cover from wear and damage.

However, the massaging element of the massaging apparatus disclosed in Patent Literature 1 is not capable of rolling in the vertical direction (not capable of rolling about a horizontally-pointing axis). Inconveniently, the massaging element is rubbed against the cover lying between the massaging element and the user, causing wear and damage to the cover.

The present invention has been devised in view of the circumstances as discussed supra, and accordingly an object of the present invention is to provide a massaging apparatus that enables a user to feel comfortable kneading and massaging effects, and also reduces wear and damage to a cover which covers massaging elements insofar as possible.

### Solution to Problem

To accomplish the above object, the following technical means is adopted for the implementation of the present invention.

A massaging apparatus pursuant to the invention comprises: a pair of horizontally arranged massaging members having massaging elements; and a massaging mechanism for producing kneading action by operating at least one of the paired massaging members so that the massaging elements have approaching and separating movement in a horizontal direction. The massaging member includes an arm member extending in a direction which is substantially perpendicular to the direction of the approaching and separating movement. The massaging element is attached to a tip of the arm member for free rotation about an axis of an extension line extending along a direction in which the arm member extends, as well as for free rotation about an axis pointing in a direction which is substantially perpendicular to the extension line.

In the present invention, it is preferable that the massaging element is attached to the tip of the arm member so as to be rotatable in a direction which is substantially parallel to the direction of approaching and separating movement of the arm member, as well as to be rotatable in a direction intersected by the direction of the approaching and separating movement.

In the present invention, it is preferable that the tip of the arm member is provided with a first shaft body pointing in the extending direction of the arm member, that the first shaft body includes a second shaft body that has an axis pointing in a direction which is substantially perpendicular to the axis of the first shaft body, and is made rotatable about the axis of the first shaft body, and that the massaging element is mounted for free rotation relatively to the second shaft body.

In the present invention, it is preferable that the arm member has its ends made as an upper branchlike tip and a lower branchlike tip, respectively, and the upper branchlike tip of the arm member and the lower branchlike tip of the arm member are each provided with the massaging element.

Moreover, a chair massager pursuant to the present invention comprises: a seat portion; a backrest portion mounted on the rear side of the seat portion; and the aforestated massaging apparatus disposed within the backrest portion.

### Advantageous Effects of Invention

According to the technologies pursuant to the present invention, it is possible to enable a user to feel comfortable kneading and massaging effects, as well as to reduce wear and damage to a cover which covers massaging elements insofar as possible.

### BRIEF DESCRIPTION OF DRAWINGS

FIG. 1 is a perspective view showing a massaging apparatus and a mechanism for moving the massaging apparatus up and down.

FIG. 2 is a perspective view showing the upper part of the massaging apparatus.

FIG. 3 is a perspective view of the structure of a massaging element, showing the structure of the upper part of the massaging element in a vertically rotated state (rotated about an axis of a second shaft body).

FIG. 4 is a perspective view of the structure of the massaging element, showing the structure of the upper part of the massaging element in a horizontally rotated state (rotated about an axis of a first shaft body).

FIG. 5 is a sectional view of a massaging member, showing the section including the axis of the first shaft body alone.

FIG. 6 is a sectional view of the massaging member, showing the section including both the axis of the first shaft body and the axis of the second shaft body.

FIG. 7 is a perspective view showing a chair massager pursuant to the present invention.

### DESCRIPTION OF EMBODIMENTS

Hereinafter, embodiments of the present invention will be described with reference to drawings.

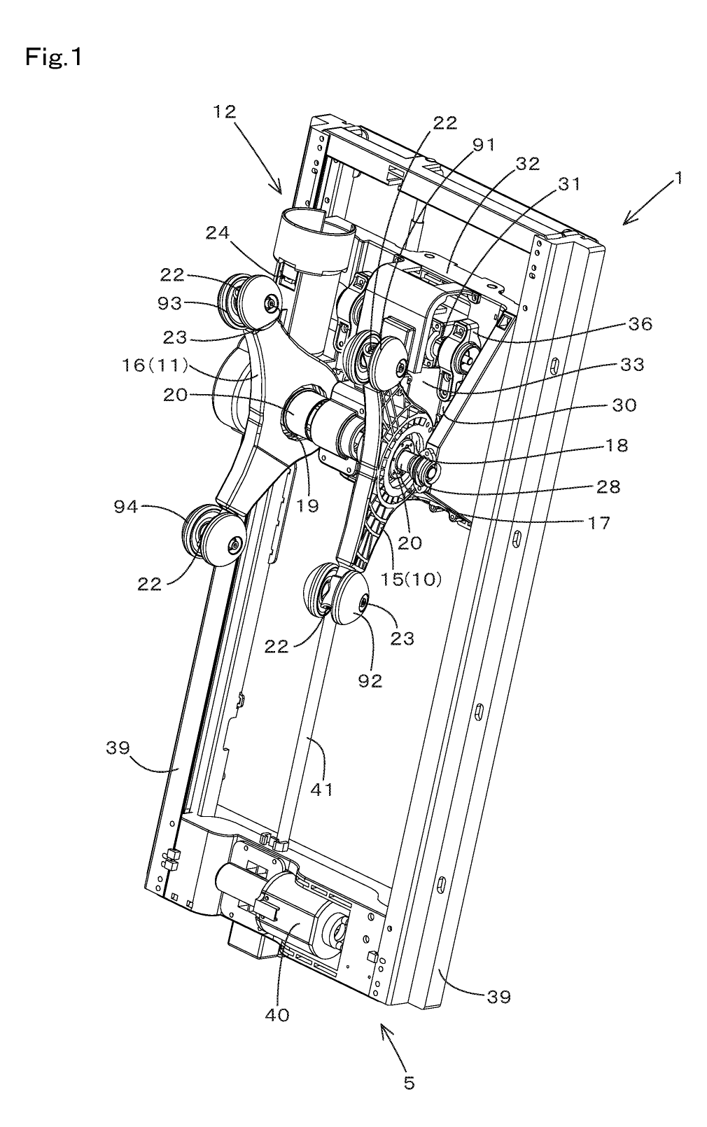

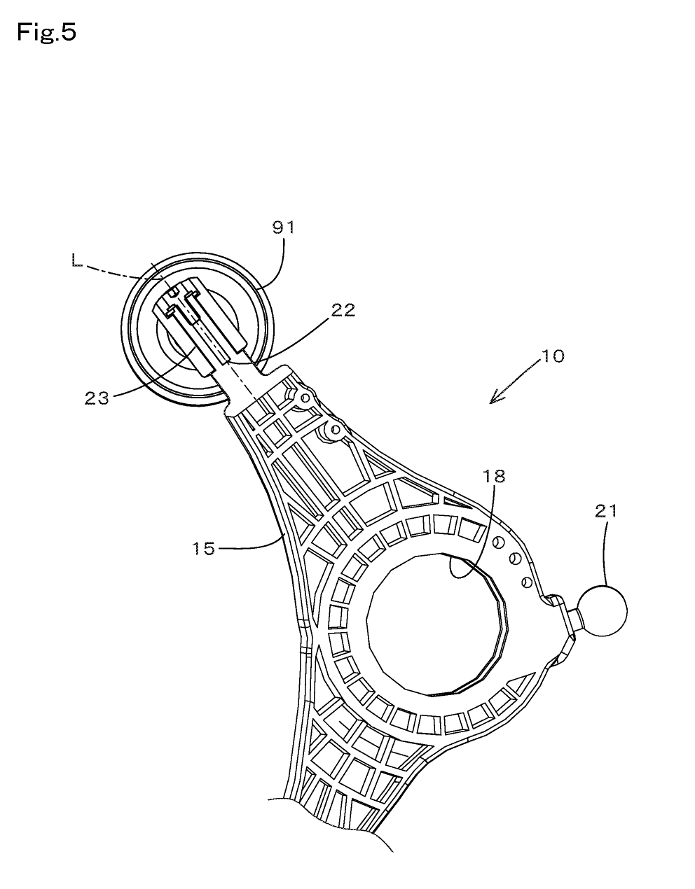

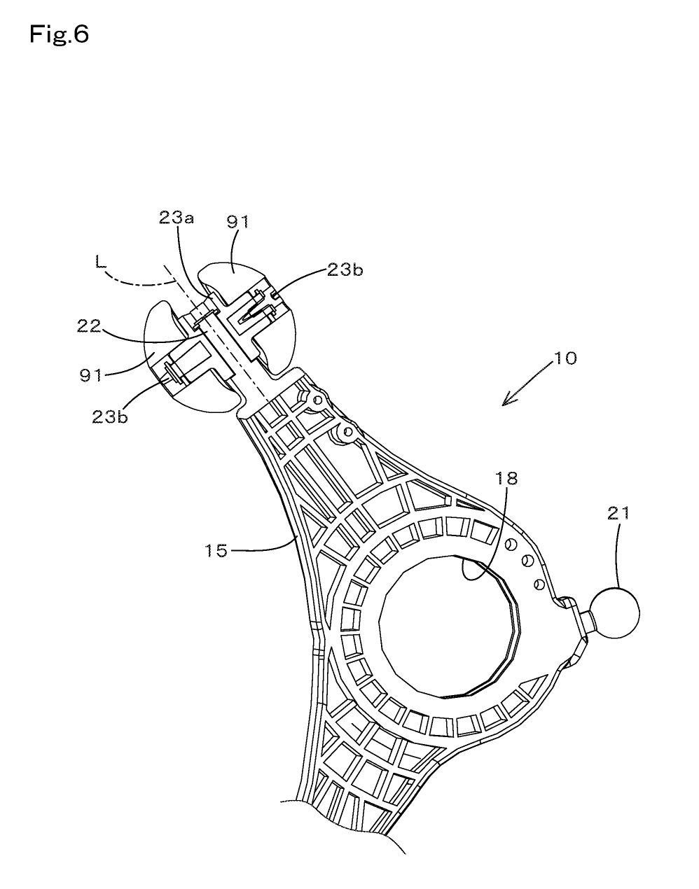

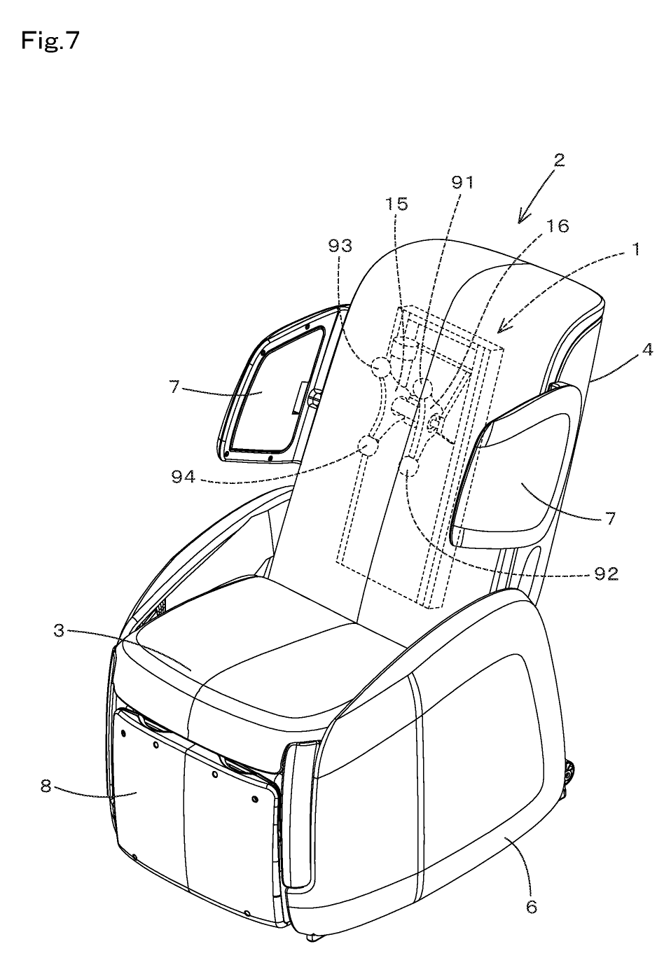

FIGS. 1 to 6 are views showing embodiments of a massaging apparatus 1 pursuant to the present invention, and FIG. 7 is a view showing an embodiment of a chair massager 2 equipped with the massaging apparatus 1.

In what follows, for the sake of description of the structure of the massaging apparatus 1, the direction of the height of a backrest portion 4 in an upstanding condition is defined as a vertical direction, and, a horizontal direction and a front-to-rear direction are determined on the basis of the vertical direction. The thereby defined directions conform to a vertical direction, a horizontal direction, and a front-to-rear direction, respectively, based on the sight of a user sitting on the chair massager 2.

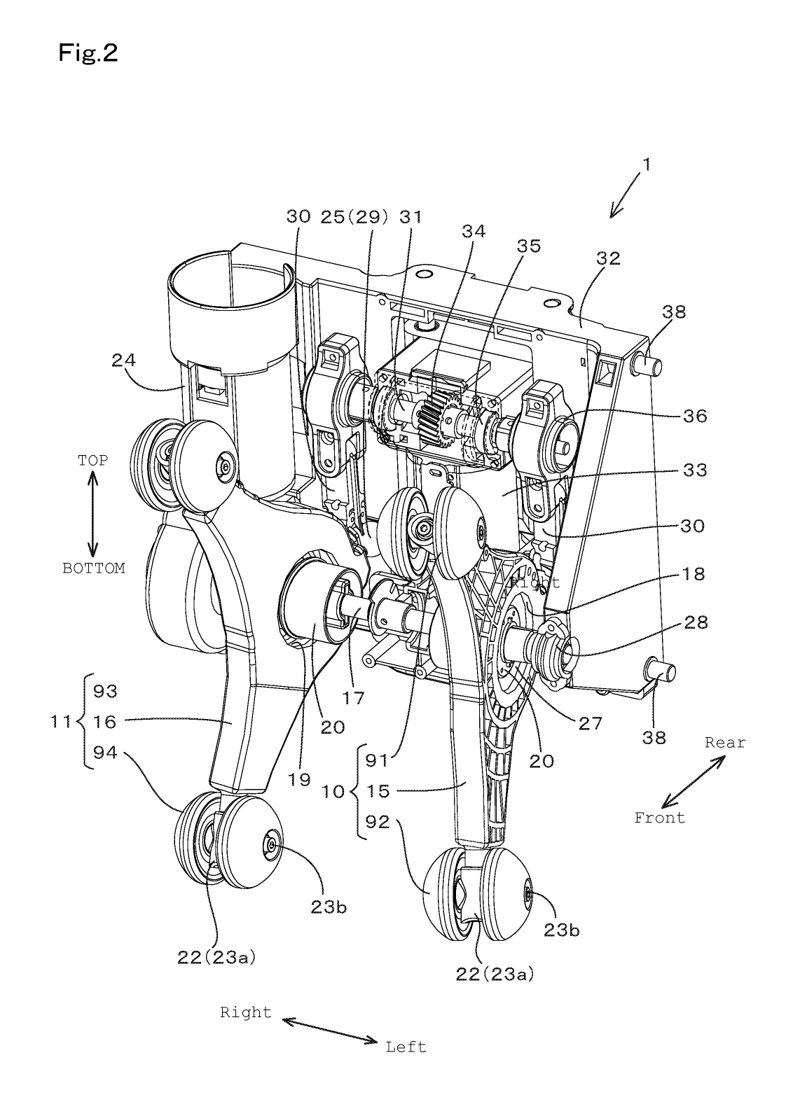

Moreover, the top-to-bottom direction, the right-to-left direction, and the front-to-rear direction indicated in the drawings such for example as FIG. 2 will be employed as the vertical direction, the horizontal direction (width direction), and the front-to-rear direction, respectively, to describe the massaging apparatus 1.

As shown in FIG. 7, the chair massager 2 comprises a seat portion 3 for supporting the buttocks of a user from below, and a backrest portion 4 mounted at the rear of the seat portion 3. The backrest portion 4 is internally provided with the massaging apparatus 1 and a vertical movement mechanism 5 for enabling the massaging apparatus 1 to move in the vertical direction.

Leg frames 6 are positioned one on either side of the seat portion 3 in the horizontal direction for support for the seat portion 3 and for placement of the chair massager 2 on the floor. The backrest portion 4 has its lower end pivotally mounted upon the rear side of the seat portion 3 or the rear side of the leg frame 6 for rotation about a horizontal axis, and can be moved into a reclined position in the front-to-rear direction by a reclining mechanism disposed inside the leg frame 6.

Moreover, upper-arm massaging devices 7 are positioned one on either side of the backrest portion 4 in the horizontal direction. Meanwhile, the front side of the seat portion 3 is provided with a leg massaging device 8 capable of leg massage. It is noted that the components given above are cited merely by way of example and without limitation as to constituent components of the chair massager 2 and the detailed design of them.

As shown in FIGS. 1 and 2, the massaging apparatus 1 comprises: a massaging member 10 and a massaging member 11 arranged at a predetermined spacing in the horizontal direction, including massaging elements 91 to 94 disposed at the corresponding tips of the massaging members 10 and 11; and a massaging mechanism 12 for producing kneading action by operating at least one of the paired massaging members 10 and 11 so that the massaging elements 91 to 94 have approaching and separating movement in the horizontal direction.

The massaging mechanism 12 has a kneading-massage driving section for performing kneading massage on user's body area ranging from the shoulder to the back, and from there to the waist (that is, a to-be-massaged body area). Moreover, the massaging apparatus 1 is provided with a tapping-massage driving section for performing tapping massage on user's body area ranging from the shoulder to the back, and from there to the waist. The tapping-massage driving section is provided independently of the kneading-massage driving section. The massaging apparatus 1 can be freely moved in the vertical direction by the above-mentioned vertical movement mechanism 5.

More specifically, the massaging apparatus 1 comprises: the left massaging member 10 mounted on the left side of the apparatus; the right massaging member 11 mounted on the right side of the apparatus; and the massaging mechanism 12 for operating the paired massaging members 10 and 11.

The following description deals mainly with the left massaging member 10 out of the paired massaging members 10 and 11. The right massaging member 11, while being disposed in horizontally symmetrical relation to the left massaging member 10 in respect of the arrangement of constituent members, has the same constitution as the left massaging member 10, wherefore the description of the right massaging member 11 will be omitted.

The left massaging member 10 comprises a left arm member 15 (arm member) protruding toward a user (toward the front) from a base member 32 of the massaging apparatus 1. The left arm member 15 has its two noses (tips) extended in different directions, and more specifically, one of the tips extends obliquely upwardly, and the other extends obliquely downwardly. These branchlike upper and lower tips are each provided with a massaging element (an upper-left massaging element 91 and a lower-left massaging element 92). The right massaging member 11 is similar in configuration to the left massaging member 10.

That is, when the left arm member 15 and a right arm member 16 are moved close to and away from each other, then the upper-left massaging element 91 of the left arm member 15 and an upper-right massaging element 93 of the right arm member 16 are moved close to and away from each other correspondingly in the horizontal direction, and also the lower-left massaging element 92 of the left arm member 15 and a lower-right massaging element 94 of the right arm member 16 are moved close to and away from each other correspondingly in the horizontal direction. Consequently, a to-be-massaged area of user's back is held between the upper massaging elements 91 and 93, as well as between the lower massaging elements 92 and 94, thus performing kneading massage on the to-be-massaged area.

As shown in FIGS. 1 and 2, the left arm member 15 (each arm member) is shaped in a substantially boomerang as seen in a side view (when viewed from the left side). More specifically, the left arm member 15 is a vertically elongated platy member shaped so that an intermediate part in the vertical direction is bent rearwardly, and thus the upper end extends obliquely upwardly in a forward direction beyond the vertically intermediate part, and the lower end extends obliquely downwardly in the forward direction beyond the vertically intermediate part.

Moreover, in the left arm member 15, the vertically intermediate part extends rearwardly in the form of a widened portion beyond the upper end and the lower end as seen in a side view. In this widened intermediate portion, an insertion hole 18 is formed so as to pass through the left arm member 15 in the horizontal direction for insertion of a first rotary shaft 17 (which will hereafter be described in detail). Furthermore, the left arm member 15 is shaped so that the upper end extends obliquely upwardly in the forward direction, whereas the lower end extends obliquely downwardly in the forward direction, with respect to the intermediate portion. In addition, the upper end of the left arm member 15 is provided with the massaging element 91, and the lower end of the left arm member 15 is provided with the massaging element 92.

The vertically intermediate portion of the left arm member 15 is formed with the insertion hole 18. Each insertion hole 18 is formed so as to pass through the corresponding arm member 15 in the horizontal direction. The insertion hole 18 opens in substantially circular form into both of the left side surface and the right side surface of the arm member 15, thus enabling insertion of the first rotary shaft 17 and an inclined rotating member 20 which will hereafter be described into the arm member 15.

Meanwhile, the upper tip and the lower tip of the left arm member 15 are each provided with a first shaft body 22. A single first shaft body 22 in the form of a cylindrical rodlike member is attached to each tip of the left arm member 15 so as to extend in the extending direction of the tip.

More specifically, as shown in FIGS. 1 and 2, the first shaft body 22 extends outwardly in the same direction as the extending direction of the left arm member 15 from the nose of the left arm member 15. For example, where the upper-left first shaft body 22 is concerned, since the upper end of the left arm member 15 extends obliquely upwardly in the forward direction from the intermediate portion, it follows that the first shaft body 22 is disposed along the same direction as the extending direction of the left arm member 15 (so as to extend obliquely from the lower rear side to the upper front side of the apparatus). The outer periphery of the first shaft body 22 is provided with a second shaft member 23.

The second shaft member 23 comprises a cylindrical body 23a which covers the first shaft body 22, and a second shaft body 23b formed in a lengthwise intermediate part of the cylindrical body 23a so as to pass through the first shaft body 22 while pointing in a direction which is substantially perpendicular to the direction of the axis of the first shaft body 22.

The second shaft member 23, which is a member shaped in a cross as seen in a side view, has its cylindrical body 23a exteriorly fitted to the first shaft body 22, and is attached to the first shaft body 22 for free rotation about the axis of the first shaft body 22 via a fastening tool. That is, in the second shaft member 23, when the cylindrical body 23a is rotated about the axis of the first shaft body 22, then the second shaft body 23b pointing in a direction which is substantially perpendicular to the axis of the cylindrical body 23a is rotated about the axis of the first shaft body 22 correspondingly.

Moreover, each arm member 15 has, at its rear end face, a restraint pin 21 for restraining the arm member 15 against following rotation. The first rotary shaft 17, the inclined rotating member 20, and the restraint pin 21 will hereafter be described in detail.

The left arm member 15 has two massaging elements 91 and 92.

The massaging elements 91 and 92 are attached to the opposite tips, respectively, of the left arm member 15 for free rotation about an axis of an extension line L extending along the extending direction of the left arm member 15, as well as for free rotation about an axis pointing in a direction which is substantially perpendicular to the extension line L.

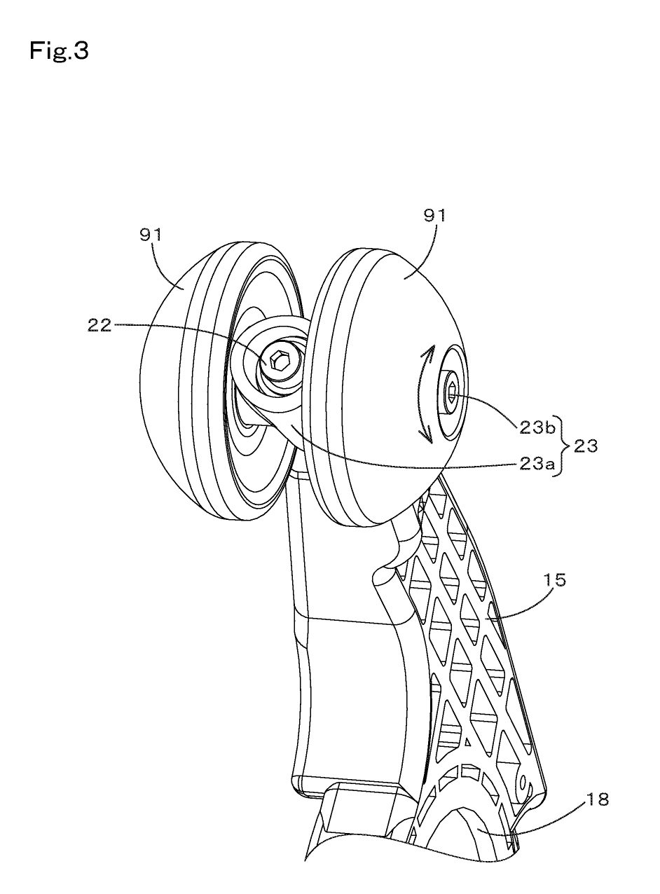

More specifically, as shown in FIGS. 3 to 6, there are provided the massaging elements 91 and 92 located at two opposite tips (the upper end and the lower end), respectively, of the left arm member 15. The massaging elements 91 and 92 are each disposed so that the extension line L extending along the extending direction of the left arm member 15 passes through the interior of the massaging element 91, 92.

Each tip of the left arm member 15 is provided with the first shaft body 22 pointing in the extending direction of the tip and the second shaft member 23 having the second shaft body 23b disposed substantially perpendicularly to the axis of the first shaft body 22 (the extension line L). The massaging elements 91 and 92 are each attached to the second shaft body 23b so as to hold the corresponding first shaft body 22 in sandwich relation. That is, the massaging elements 91 and 92 are each rotatably attached to the second shaft body 23b so that the center of rotation of the massaging element 91, 92 coincides with the axis of the second shaft body 23b. Moreover, the second shaft body 23b is also rotatable about the axis of the first shaft body 22. Thus, the massaging elements 91 and 92 are each rotatable about the axis of the first shaft body 22, as well as about the axis of the second shaft body 23b, in the left arm member 15. That is, the massaging elements 91 and 92 are each designed in spherical form for universal rotation in three dimensions about two axes of rotation.

The massaging elements 91 and 92 are each composed of a set of two semi-spherical members (convexly-curved members) that are obtained by equally dividing a spherical or ellipsoidal object made of a material having high elasticity such for example as hard rubber. The massaging elements 91 and 92 are each attached to the second shaft body 23b via a fastening tool, with the cross sections of the semi-spherical members opposed to each other, with the second shaft body 23b disposed so as to pass all the way through from the apex of the member to the center of the cross section, and with the cylindrical body 23a held between the cross sections of the members.

For example, the upper-left massaging element 91 is mounted for free rotation about the axis of the first shaft body 22 disposed so as to extend obliquely upwardly in the forward direction from the upper end face of the left arm member 15, with the first shaft body 22 held between the cross sections of the two members of the massaging element set.

That is, in the massaging elements 91 to 94 including the upper-left massaging element 91 set as above described, each massaging element can be considered to be situated in a position where the extension line L extending in the extending direction of each arm member 15, 16 from the nose of each arm member 15, 16 passes through the interior of the massaging element.

The massaging elements 91 and 92 are each rotatable about the axis of the first shaft body 22 (or equivalently the axis of the cylindrical body 23a), as well as about the axis of the second shaft body 23b. That is, the massaging elements 91 and 92 are each designed so that the semi-spherical members constituting the massaging element set rotate unitarily about the axis of the first shaft body 22, and rotate individually about the axis of the second shaft body 23b.

For example, upon rotating the upper-left massaging element 91 about the axis of the first shaft body 22, the upper-left massaging element 91 rotates in a direction which is substantially parallel to the direction of the approaching and separating movement of the left arm member 15. At the same time, upon rotating the upper-left massaging element 91 about the axis of the second shaft body 23b, the upper-left massaging element 91 rotates in a direction intersected by the direction of the approaching and separating movement of the left arm member 15 (vertical direction).

Thus, in rotating the massaging elements 91 and 92, not only it is possible to effect two axial rotations simultaneously, or more specifically to effect rotations about two axes, namely the axis of the first shaft body 22 and the axis of the second shaft body 23b simultaneously, but it is also possible to effect a rotation about the axis of the first shaft body 22 and a rotation about the axis of the second shaft body 23b independently.

To sum up, the massaging elements 91 to 94 are capable of rotations about two axes, namely the axis of the first shaft body 22 and the axis of the second shaft body 23b, and thus, for example, when the massaging mechanism 12 is operated to move in the vertical direction to perform massage on a vertically long to-be-massaged area such as user's back, in response to the rocking motion of the arm members 15 and 16 to move close to and away from each other while moving in the vertical direction, as shown in FIG. 3, the massaging elements 91 to 94 are rotated mainly about the axis of the second shaft body 23b. In this case, the vertical rolling motion of the massaging elements 91 to 94 makes it possible to avoid without fail that the massaging elements 91 to 94 are rubbed vertically against a cover lying between a user and the massaging elements 91 to 94, causing damage to the cover.

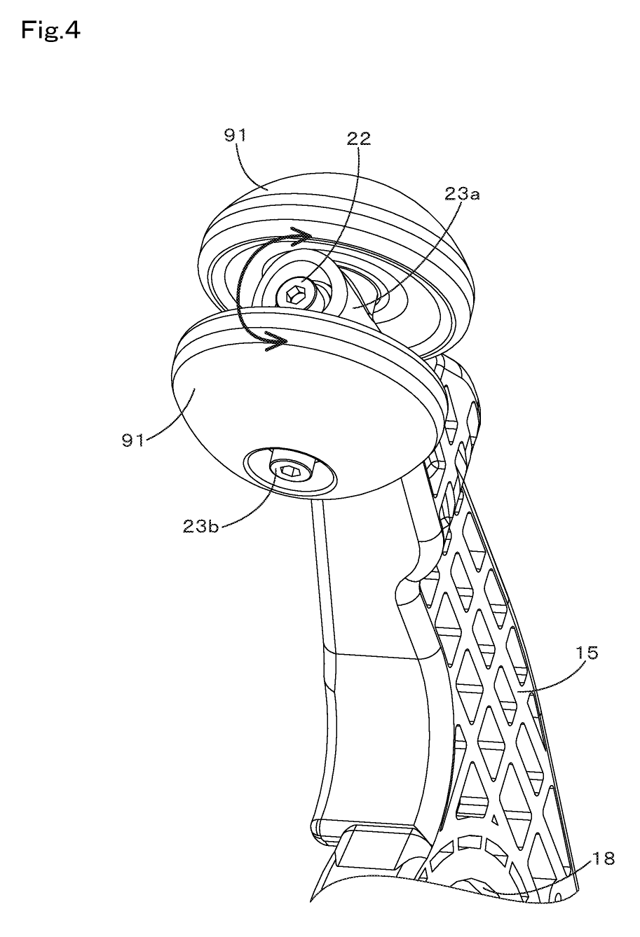

Moreover, for example, when the massaging mechanism 12 is brought to a halt at a predetermined to-be-massaged area such as user's waist to perform massage on the to-be-massaged area, in response to the rocking motion of the arm members 15 and 16 to move close to and away from each other, as shown in FIG. 4, the second shaft body 23b is rotated about the axis of the first shaft body 22, and the massaging elements 91 to 94 are rotated mainly about the axis of the first shaft body 22 correspondingly. Also in this case, the horizontal rolling motion of the massaging elements 91 to 94 makes it possible to avoid without fail that the massaging elements 91 to 94 are rubbed horizontally against the cover lying between the user and the massaging elements 91 to 94, causing damage to the cover.

Moreover, since the massaging elements 91 to 94 are each able to roll both in the vertical direction and in the horizontal direction like a roller, it is possible to achieve kneading massage by operating the massaging elements 91 to 94 to roll over the surface of a to-be-massaged body area of a user, and thereby enable the user to feel distinctive massaging effects that cannot be obtained just by pressing the massaging elements 91 to 94 against the to-be-massaged area.

The following describes the massaging mechanism 12 for rocking the massaging elements and the massaging member 10 thus far described.

A variety of driving means or power transmission mechanisms may be adopted for use as such a massaging mechanism 12. In what follows, the massaging apparatus 1 embodying the present invention will be illustrated as incorporating, as the massaging mechanism 12, for example, a system for effecting massage by converting the rotational driving force exerted by a kneading motor 24 and a tapping motor 33 into kneading action and tapping action.

The aforestated massaging mechanism 12 comprises: a kneading driving section for imparting kneading motion to the left and right massaging members 10 and 11; a tapping driving section for imparting tapping motion to the left and right massaging members 10 and 11; and a vertical movement mechanism 5 for enabling the massaging apparatus 1 (the left and right massaging members 10 and 11, the kneading driving section, and the tapping driving section) to move in the vertical direction within the backrest portion 4.

The kneading driving section is designed to effect kneading massage for a to-be-massaged body area by driving the arm members 15 and 16 so that their tips move close to and away from each other in the horizontal direction relative to their base ends, and in fact the tips are rocked in response to the horizontal rocking motion of the base ends of the arm members 15 and 16.

Specifically, the kneading driving section has the inclined rotating members 20 inserted in the insertion holes 18 and 19 of, respectively, the massaging members 10 and 11. Located centrally of the inclined rotating member 20 is the first rotary shaft 17 passing through the inclined rotating member 20 in the axial direction. The first rotary shaft 17 is laid on the base member 32 while passing through the left and right inclined rotating members 20 so as to provide communication between these members, with its axis pointing in the horizontal direction. The first rotary shaft 17 and the inclined rotating member 20 constitute the kneading driving section. Moreover, the kneading driving section has a kneading motor 24 for rotatably driving the first rotary shaft 17, and a swing preventive mechanism 25 disposed on the rear side of the massaging member 10, 11 for restraining the arm member 15, 16 from rotating in response to the rotation of the first rotary shaft 17.

The inclined rotating member 20 is a cylindrical member attached to an intermediate part of the first rotary shaft 17, and the outside diameter of the inclined rotating member 20 is greater than that of the first rotary shaft 17. Moreover, the inclined rotating member 20 is disposed in coaxial relation to the first rotary shaft 17, and, the outer periphery surface of the inclined rotating member 20 is stepped to define a shoulder for the placement of a bearing 27. The shoulder is inclined with respect to the axis of the inclined rotating member 20, is formed along a circular trackway around the axis, and rotatably supports the arm member 15, 16 relative to the inclined rotating member 20.

The first rotary shaft 17 is a horizontally-extending shaft member disposed so as to provide communication between the center of the insertion hole 18 of the aforestated left massaging member 10 and the center of the insertion hole 19 of the right massaging member 11. The first rotary shaft 17 is, at its horizontally opposite ends, rotatably supported on the base member 32 via shaft bearings 28. Moreover, the right-hand end of the first rotary shaft 17 is provided with the kneading motor 24 for driving the first rotary shaft 17 to rotate about a horizontally-pointing axis.

Specifically, the driving shaft of the kneading motor 24 is provided with a power transmitting member constructed of a worm gear. Upon rotating the power transmitting member by the kneading motor 24, the first rotary shaft 17 is driven to rotate.

The swing preventive mechanism 25 is intended to restrain the left massaging member 10 and the right massaging member 11 from rotating in response to the rotation of the first rotary shaft 17. For example, by engaging a universal coupling 29, such as a ball joint or a universal joint, with the rear-end side of each massaging member 10, 11, it is possible to implement the swing preventive mechanism 25 for restraining the rotation (following rotation) of each massaging member 10, 11.

In the swing preventive mechanism 25, each massaging member 10, 11 is connected to a second rotary shaft 31 of the tapping driving section via a link lever 30 of the tapping driving section that will hereafter be described, thus restraining each massaging member 10, 11 against following rotation. Specifically, the rear-end side of the arm member 15, 16 of each massaging member 10, 11 is provided with the rearwardly-protruding restraint pin 21. The restraint pin 21 has its tip (rear end) rounded in spherical form, and, this spherical end of the restraint pin 21 engages with the universal coupling 29 disposed at the tip of the link lever 30 of the tapping driving section, so that the arm member 15, 16 can be coupled for free rocking motion in the front-to-rear direction, the horizontal direction, and the vertical direction relatively to the tapping driving section.

Accordingly, even when the first rotary shaft 17 is rotated, since the arm member 15, 16 of each massaging member 10, 11 is retained by the swing preventive mechanism 25, thus restraining each massaging member 10, 11 from rotating in response to the rotation of the first rotary shaft 17.

The tapping driving section comprises: the second rotary shaft 31 located above the first rotary shaft 17 in parallel relation thereto, with its axis pointing in the horizontal direction; and the tapping motor 33 for rotatably driving the second rotary shaft 31.

Specifically, the driving shaft of the tapping motor 33 is connected to a gear 34 located centrally of the second rotary shaft 31 in the horizontal direction. Upon rotatably driving the tapping motor 33, a rotational driving force exerted by the motor is transmitted to the second rotary shaft 31 through the gear 34, thus driving the second rotary shaft 31. Moreover, a shaft bearing 35 is disposed on the second rotary shaft 31 outwardly of the gear 34, and the second rotary shaft 31 is free to rotate about a horizontally-pointing axis via the shaft bearing 35. In addition, eccentric drivers 36 are positioned one on either side of the second rotary shaft 31 outwardly of the shaft bearing 35 in the horizontal direction, and these left and right eccentric drivers 36 are eccentrically mounted with a phase difference of 180° with respect to the second rotary shaft 31. The link lever 30 (crankshaft) is disposed so as to extend downwardly from each eccentric driver 36.

The eccentric driver 36 is not axially aligned with the second rotary shaft 31. That is, upon driving the tapping motor 33, the eccentric driver 36 is eccentrically rotated about the axis of the second rotary shaft 31. Moreover, the lower end of the link lever 30 is coupled to an intermediate part of the arm member 15, 16 in the vertical direction (insertion hole 18, 19). Specifically, the restraint pin 21, which is disposed in a vertically intermediate part of the arm member 15, 16 (massaging member 10), is coupled to the lower end of the link lever 30 via the universal coupling 29. The structure of coupling between the restraint pin 21 and the link lever 30 constitutes the swing preventive mechanism 25 comprising the above-mentioned universal coupling 29.

Accordingly, in the tapping driving section, upon driving the tapping motor 33, the eccentric driver 36 is eccentrically rotated about the axis of the second rotary shaft 31, thus imparting vertical pushing-pulling movement to the link lever 30. Consequently, in the left and right arm members 15 and 16, their massaging elements 91 to 94 are rocked about the first rotary shaft 17 in small rocking motion so as to produce tapping action. Since the left and right eccentric drivers 36 are eccentrically mounted with a phase difference of 180° with respect to the second rotary shaft 31, it follows that the massaging element 91, 92 of the left massaging member 10 and the massaging element 93, 94 of the right massaging member 11 are moved oppositely in the horizontal direction, wherefore the left massaging member 10 and the right massaging member 11 produce tapping action on an alternate basis.

Although the left and right arm members 15 and 16 undergo rocking motion on an alternate basis due to the arrangement of the left and right eccentric drivers 36 with a phase difference of 180°, the movement of the massaging elements 91 to 94 is not limited to that as above described.

The following describes the base member 32 for supporting the aforestated massaging apparatus 1 and the vertical movement mechanism 5 for enabling the base member 32 to move in the vertical direction within the backrest 4.

A backrest frame is disposed inside the above-mentioned backrest portion 4, and, the vertical movement mechanism 5 is attached to the backrest frame. The vertical movement mechanism 5 comprises: the base member 32 provided with the massaging mechanism 12; and guide rollers 38 rotatably held on the left side and the right side of the upper part of the base member 32 and the left side and the right side of the lower part thereof, respectively, with their axes of rotation extending horizontally outwardly. In addition, there is provided a pair of left and right guide rails 39 for guiding the guide rollers 38 fitted therein for vertical movement. The guide rail 39 is incorporated in the backrest portion 4 so that the direction of its length is aligned with the vertical direction.

Moreover, in a location midway between the opposite guide rails 39 is disposed a screw shaft 41 which can be rotatably driven by an up-and-down motor 40, and, the base member 32 has a built-in nut member (not shown in the drawings) which threadedly engages with the screw shaft 41. Accordingly, as the screw shaft 41 is driven to rotate by the actuation of the up-and-down motor 40, the nut member converts a force exerted in the direction of rotation of the screw shaft 41 into a translational force, thus allowing the base member 32 and the massaging mechanism 12 to move up and down together in the interior of the backrest portion 4.

With this construction, a user sitting on the seat portion 3 while leaning against the backrest portion 4 is able to have massage in a wide body range extending from the shoulder to the back, and from there to the waist, by moving the massaging mechanism 12 up and down.

[Workings]

Next, how massage is to be performed by means of the massaging elements 91 to 94, the massaging member 10, and the massaging mechanism 12 thus far described, in other words, a massaging method pursuant to the present invention, will be described with a particular emphasis on kneading massage.

The first step to effect kneading massage is to drive the kneading motor 24. Upon driving the kneading motor 24, the first rotary shaft 17 connected to the kneading motor 24 is rotated about a horizontally-pointing axis, and the inclined rotating member 20 attached coaxially to the first rotary shaft 17 is rotated about a horizontally-pointing axis correspondingly.

Then, in response to the rotation of the inclined rotating member 20, a rotational driving force is exerted on the massaging members 10 and 11, thus rotating the massaging members 10 and 11 about a horizontally-pointing axis. Note that the massaging member 10, 11 is attached to the shoulder 26 formed with inclination at the outer periphery surface of the inclined rotating member 20 via the bearing 27, and is therefore rotated about an axis inclined with respect to the horizontally-pointing axis. Consequently, the aforestated massaging member 10 is rotated about an axis inclined with respect to the horizontal direction.

At this time, in the arm member 15, 16, the tip side is rocked up and down, from side to side, and back and forth at predetermined angles with reference to the base-end side by the swing preventive mechanism 25 implemented by coupling the restraint pin 21 to the universal coupling 29 of the link lever 30. Accordingly, the massaging member 10, 11 will not be rotated together with the inclined rotating member 20, and is thus allowed to move only in the direction of horizontal rocking motion. Consequently, in the massaging member 10, 11, the tip side is rocked from side to side with reference to the base-end side.

For example, when the left massaging member 10 is operated so that the massaging element 91 moves rightward, then the massaging element 92 moves leftward. At this time, in the right massaging member 11, the massaging element 93 moves leftward, whereas the massaging element 94 moves rightward. That is, the left massaging element 91 and the right massaging element 93 move close to each other, whereas the left massaging element 92 and the right massaging element 94 move away from each other.

On the other hand, when the left massaging member 10 is operated so that the massaging element 91 moves leftward, then the massaging element 92 moves rightward. At this time, in the right massaging member 11, the massaging element 93 moves rightward, whereas the massaging element 94 moves leftward. That is, the left massaging element 91 and the right massaging element 93 move away from each other, whereas the left massaging element 92 and the right massaging element 94 move close to each other.

With the repetition of such approaching and separating movement, a to-be-massaged body area can be held by the massaging elements 91 to 94 in sandwich style, thus effecting kneading action (kneading massage) for the to-be-massaged body area.

The four massaging elements 91 to 94 are rotated about both of the axis of the first shaft body 22 pointing in a direction which is substantially perpendicular to the direction of the approaching and separating movement (the axis pointing in the extending direction of the arm member 15, 16) and the axis of the second shaft body 23b, that is; rotated for universal rolling motion like a ball. Thus, the massaging elements 91 to 94, being able to roll smoothly in the direction of rocking motion of the arm member 15, 16, are each movable smoothly in the horizontal direction. Consequently, the four massaging elements 91 to 94 roll smoothly without making frictional contact such as rubbing contact with the cover and so forth. That is, the four massaging elements 91 to 94, being capable of rotation about the axes of the first shaft body 22 and the second shaft body 23b, will not place any load which causes wear and damage to the cover.

Moreover, this construction makes it possible to produce distinctive massaging and kneading effects that cannot be obtained from rubbing massage made by a non-rotatable massaging element, and thereby perform sophisticated and non-boring kneading massage on a to-be-massaged body area.

Moreover, since the massaging elements 91 to 94 are each rotatably reciprocated both in the vertical direction and in the horizontal direction like a roller, it never occurs that the massaging elements 91 to 94 are each rubbed strongly against a bumped-up to-be-massaged area on the body surface. This makes it possible to perform comfortable kneading massage on the to-be-massaged area at all times.

The embodiment disclosed herein should be considered in all respects as illustrative and not restrictive. The scope of the present invention is not defined by the foregoing description but defined by the scope of the appended claims, and all changes that come within the meaning and the range of equivalency of the claims are therefore intended to be embraced therein.

Moreover, although the aforestated embodiment exemplifies a four-ball type massaging apparatus having the massaging elements 91 to 94 attached to the upper and lower sides of the left arm member 15 and the upper and lower sides of the right arm member 16, respectively, the arm members of the present invention are not structurally limited to these paired left and right arm members 15 and 16. The present invention is applicable to a two-ball type massaging apparatus in which the paired left and right arm members 15 and 16 are each provided with a single massaging element.

Moreover, although the massaging elements 91 to 94 are each constructed of a member having a substantially spherical or ellipsoidal outer appearance in the aforestated embodiment, the massaging elements 91 to 94 may be given different outer appearance. For example, the massaging elements 91 to 94 may be polygonally shaped.

In addition, although the first shaft body 22 and the second shaft body 23 are provided independently of each other as separate components in the aforestated embodiment, these members may be formed integrally in one piece.

### EXPLANATION OF REFERENCE SYMBOLS

1 Massaging apparatus
2 Chair massager
3 Seat portion
4 Backrest portion
5 Vertical movement mechanism
6 Leg frame
7 Upper-arm massaging device
8 Leg massaging device
10 Left massaging member
11 Right massaging member
12 Massaging mechanism
15 Left arm member
16 Right arm member
17 First rotary shaft
18 Left insertion hole
19 Right insertion hole
20 Inclined rotating member
21 Restraint pin
22 First shaft body
23 Second shaft member
23a Cylindrical body
23b Second shaft body
24 Kneading motor
25 Swing preventive mechanism
27 Bearing
28 Shaft bearing
29 Universal coupling
30 Link lever
31 Second rotary shaft
32 Base member
33 Tapping motor
34 Gear
35 Shaft bearing
36 Eccentric driver
38 Guide roller
39 Guide rail
40 Up-and-down motor
41 Screw shaft
91 Upper-left massaging element
92 Lower-left massaging element
93 Upper-right massaging element
94 Lower-right massaging element

1. A massaging apparatus comprising:
a pair of horizontally arranged massaging members having massaging elements; and
a massaging mechanism for producing kneading action by operating at least one of said paired massaging members so that said massaging elements have approaching and separating movement in a horizontal direction,
said massaging member including an arm member extending in a direction which is substantially perpendicular to a direction of said approaching and separating movement,
said massaging element being attached to a tip of said arm member for free rotation about an axis of an extension line extending along a direction in which said arm member extends, as well as for free rotation about an axis pointing in a direction which is substantially perpendicular to the extension line.

2. The massaging apparatus according to claim 1,
wherein said massaging element is attached to the tip of said arm member so as to be rotatable in a direction which is substantially parallel to the direction of approaching and separating movement of said arm member, as well as to be rotatable in a direction intersected by the direction of said approaching and separating movement.

3. The massaging apparatus according to claim 2,
wherein the tip of said arm member is provided with a first shaft body pointing in the extending direction of said arm member,
wherein said first shaft body includes a second shaft body that has an axis pointing in a direction which is substantially perpendicular to an axis of the first shaft body, and is made rotatable about the axis of said first shaft body,
and wherein said massaging element is mounted for free rotation relatively to said second shaft body.

4. The massaging apparatus according to claim 2,
wherein said arm member has its ends made as an upper branchlike tip and a lower branchlike tip, respectively,
and wherein the upper branchlike tip of said arm member and the lower branchlike tip of said arm member are each provided with the massaging element.

5. A chair massager comprising:
a seat portion;
a backrest portion mounted on a rear side of the seat portion; and
the massaging apparatus as set forth in any one of claims 1 to 4 disposed within said backrest portion.
